(19) United States
(12) Patent Application Publication
(10) Pub. No.: US 2022/0237021 A1
(43) Pub. Date: Jul. 28, 2022

(54) SYSTEMS AND METHODS OF TELEMETRY DIAGNOSTICS

(71) Applicant: salesforce.com, inc., San Francisco, CA (US)

(72) Inventor: Brandon Svec, Indianapolis, IN (US)

(21) Appl. No.: 17/158,144

(22) Filed: Jan. 26, 2021

(51) Int. Cl. G06F 9/48; G06F 9/448; G06F 9/38; G06F 9/30

(52) U.S. Cl. CPC G06F 9/485; G06F 9/30072; G06F 9/3855; G06F 9/4482

(57) ABSTRACT

Systems and method are provided for executing a workflow based on a received alert notification, wherein the workflow includes one or more tasks to be executed by a workflow processor. The workflow is validated when it is determined that each task of the workflow is executable without failure. A job may be generated based on the validated workflow, and a state object in a state engine may be generated to be used by the job for processing by the workflow processor. Each task of the state object may be iterated to complete the workflow, and data may be transmitted in response to the alert notification based on the completed workflow.

### BACKGROUND

Presently, when a system outputs an alert notification related to performance, an error, a check, or the like of a network computing system, a responding operator must know how to respond to the alert using his or her own knowledge, or follow any written procedures to address the alert. If the operator does not know how to respond and there is no documentation available for how to respond to the alert, the operator is unable to address the alert notification. That is, present systems typically output an alert notification related to a problem with the network computing system, but do not provide any information regarding resolving the problem so that the system can be restored and be usable for users.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description explain the principles of implementations of the disclosed subject matter. No attempt is made to show structural details in more detail than can be necessary for a fundamental understanding of the disclosed subject matter and various ways in which it can be practiced.

FIGS. 1-3 show example methods of executing a workflow based on an alert notification for telemetry diagnostics according implementations of the disclosed subject matter.

FIG. 4 shows an example method of complex conditional data evaluation for the methods shown in FIGS. 1-3 according to an implementation of the disclosed subject matter.

FIG. 5 shows a method of dynamically changing a threshold value for a task of the workflow of FIGS. 1-3 according to an implementation of the disclosed subject matter.

FIG. 6 shows a method of receiving, validating, and executing code conditional logic according to an implementation of the disclosed subject matter.

FIG. 7 shows an instance of a workflow engine according to an implementation of the disclosed subject matter.

FIG. 8 shows an example of workflow processing according to an implementation of the disclosed subject matter.

FIG. 9 shows another example of workflow processing that performs initial checks and server diagnostics according to an implementation of the disclosed subject matter.

FIG. 10 shows an example system that implements the methods of FIGS. 1-6 and the instance of the workflow engine shown in FIG. 7 according to an implementation of the disclosed subject matter.

### DETAILED DESCRIPTION

Various aspects or features of this disclosure are described with reference to the drawings, wherein like reference numerals are used to refer to like elements throughout. In this specification, numerous details are set forth in order to provide a thorough understanding of this disclosure. It should be understood, however, that certain aspects of disclosure can be practiced without these specific details, or with other methods, components, materials, or the like. In other instances, well-known structures and devices are shown in block diagram form to facilitate describing the subject disclosure.

Implementations of the disclosed subject matter provide systems and methods of designing, implementing, and sharing workflows which gather and evaluate data points from one or more data and/or telemetry systems to enhance investigative efficacy and reduce time to resolution of an incident for a network computing system. A workflow may be written by an SME (Subject Matter Expert) to follow an investigative path to provide guidance to an operator of the network computing system. This allows SMEs to provide collective and/or tribal knowledge into a stored workflow for non-SMEs to run. The workflow may gather details from data sources to provide guidance and/or determine a problem. Workflows from various isolated system dependencies may be called, thus reducing the knowledge required by an operator to determine the cause of a particular alert and/or notification for the network computing system.

A workflow may be used to generate a query to a system. The query may access application programming interfaces (APIs) according to the workflow, and data may be returned based on the query. The returned data may be kept within the workflow, which is useful to tasks downstream. That is, information returned for a task of a workflow can be used by other tasks. As other tasks are processing data, they may access any other task's data as part of the running workflow. The data for a running workflow may be stored in a global storage to allow this.

Workflows may include one or more tasks, where data returned by the task is evaluated. A task may have a particular type, which defines a schema of the type of data returned and the format of the data. This makes it easier for other tasks to interact with the task and read the data. One task can request a particular datapoint from another task, as it knows the kind of data returned by the task. That is, implementations of the disclosed subject matter provide a global data sharing between tasks, and tasks may call other workflows.

Implementations of the disclosed subject matter may provide complex conditional data evaluation. This may provide dynamic decision making, without having to hard-code thresholds in a workflow. This may allow for using multiple datapoints to determine a condition state (i.e., a true state, a false state, or the like) without having to make code changes.

Implementations of the disclosed subject matter may provide dynamic data evaluation decision making. An interface may be used to create, provision, and run a workflow. Code conditional logic may be received via the interface. The data values and operators of the received code conditional logic may be validated before the code conditional logic is executed. The code conditional logic may be provided as input from the user so as to update operations while avoiding having to alter code.

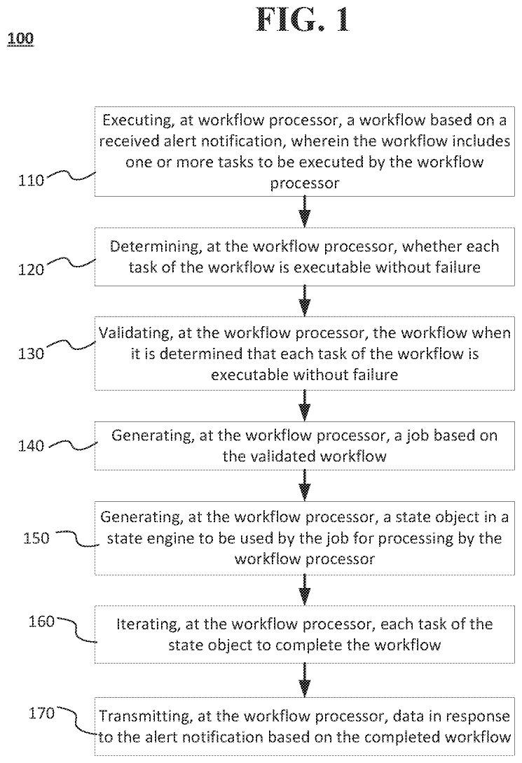

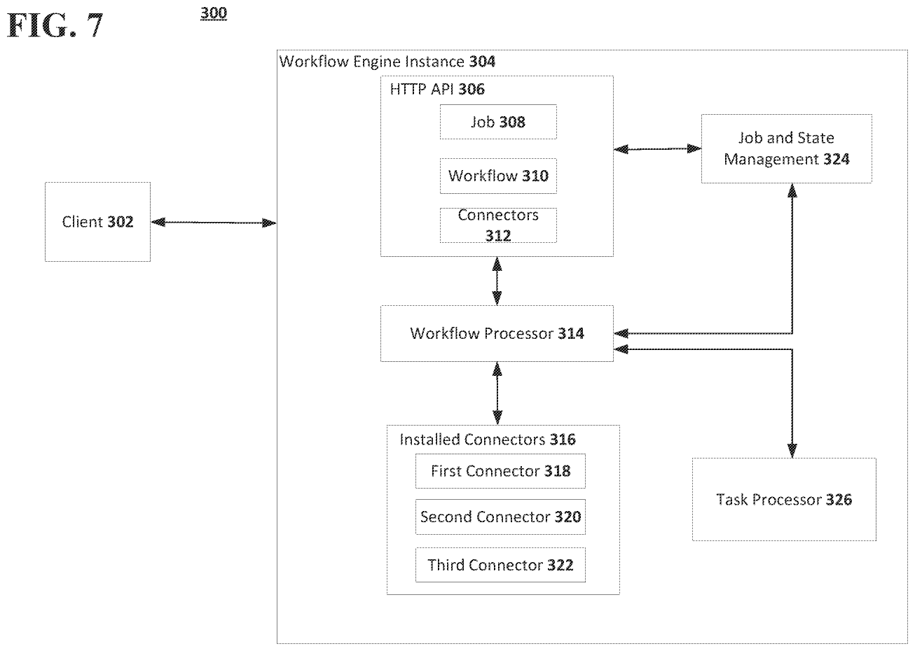

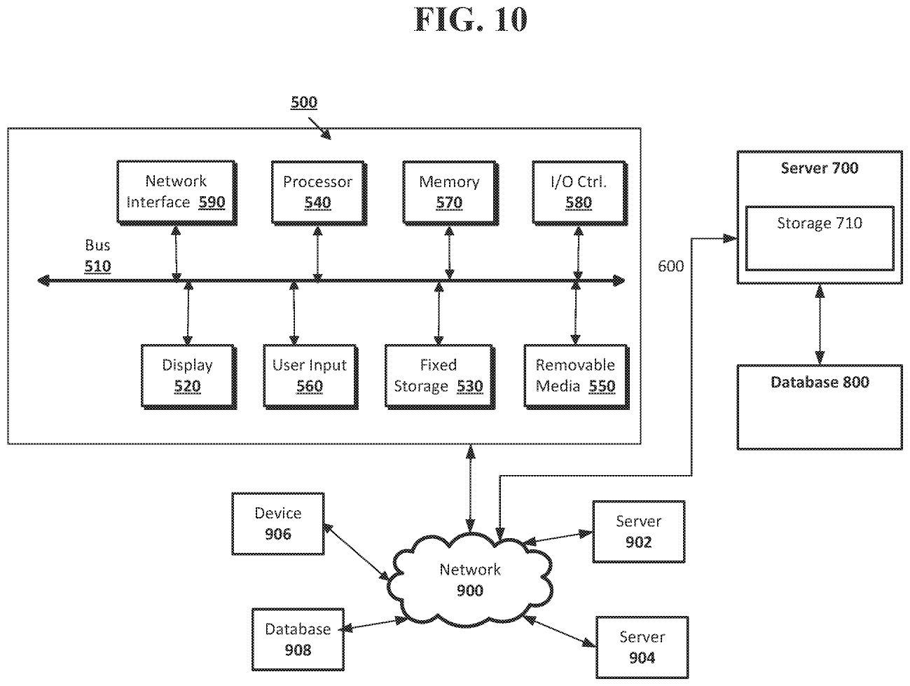

FIG. 1 shows an example method 100 of providing telemetry diagnostics for a network computing system according to an implementation of the disclosed subject matter. At operation 110, a workflow processor (e.g., workflow processor 314 shown in FIG. 7, which may be part of server 700 shown in FIG. 10) may execute a workflow based on a received alert notification. The workflow may include one or more tasks to be executed by the workflow processor. The workflow processor may orchestrate tasks based on workflow content and the results of tasks as they are processed. As used throughout, a workflow may gather and evaluate data points from one or more data systems and/or telemetry systems (e.g., Argus, Splunk, or the like) to determine an incident with the network computing system (e.g., server 902, server 902 device 906, and/or database 908 of network 900 shown in FIG. 10), and assist in resolving the incident. A workflow may be written by a Subject Matter Expert (SME), and the workflow may output information to guide a system operator of the network computing system. In some implementations, workflows may include tasks to be executed to resolve one or more operation issued with devices communicatively coupled to a network (e.g., network 900 shown in FIG. 10). As used throughout, a task may be a template for performing an action.

At operation 120, the workflow processor may determine whether each task of the workflow is executable without failure. That is, before a workflow becomes a job, it may be fully validated. In this validation, the workflow processor may evaluate each task to avoid a runtime failure. If a workflow includes a task that may not be validated, the workflow may not be executed. In some implementations, a notification may be transmitted to a client device (e.g., computer 500 shown in FIG. 10) that the workflow has not been validated, and may not be processed. For the validation of each task, the workflow processor may determine whether a connector is supported by the workflow engine instance. For example, as described below in connection with FIG. 7, workflow engine instance 304 may include installed connectors 316, which may include first connector 318, second connector 320, and/or third connector 322. The workflow engine instance may be part of server 700 shown in FIG. 10. These installed connectors 316 may be supported by the workflow engine instance 304. As used throughout, a connector may correspond with a task, and may be modular. That is, a workflow may include one or more tasks, where each task may include a pre-defined task from a connector. Connectors may be specific to downstream services, such as APIs (application program interfaces) or databases. The connectors may provide an interface between the task and one or more external telemetry diagnostic tools. The validation of each task may include validates the input parameters to determine if they meet task structure requirements. The validation may include determining whether each data point reference exists in the current workflow.

At operation 130, the workflow processor may validate the workflow when it is determined that each task of the workflow is executable without failure. The workflow may be validated by using one or more input parameters that have a first predetermined structure for the at least one task, one or more workflow parameters have a second predetermined structure for the at least one task, and/or the one or more workflow parameters match data points of the workflow. A job may be generated at operation 140 based on the validated workflow.

A state object may be generated in a state engine (e.g., job and state management 342 shown in FIG. 7) to be used by the job for processing by the workflow processor (e.g., workflow processor 314 shown in FIG. 7) at operation 150. The state object may indicate a status and/or state of one or more tasks of the job, and/or the status of the job itself. For example, the status and/or state may indicate whether the one or more tasks and/or the job have been completed, and/or whether additional work is to be performed. In some implementations, the state object may manage the state of the job. The results of the iterated and/or executed tasks may be stored. A state engine (e.g., which may be part of job and state management 324 shown in FIG. 7) may be used to store a state of a task in a storage device (e.g., storage 710 and/or database 800 shown in FIG. 10).

At operation 160, the workflow processor may iterate each task of the state object to complete the workflow. That is, the workflow processor may execute each task of the workflow. A task processor worker (e.g., of the task processor 326 shown in FIG. 7) may retrieve one or more work items of each task of the workflow, and may perform the work of each task to complete the workflow.

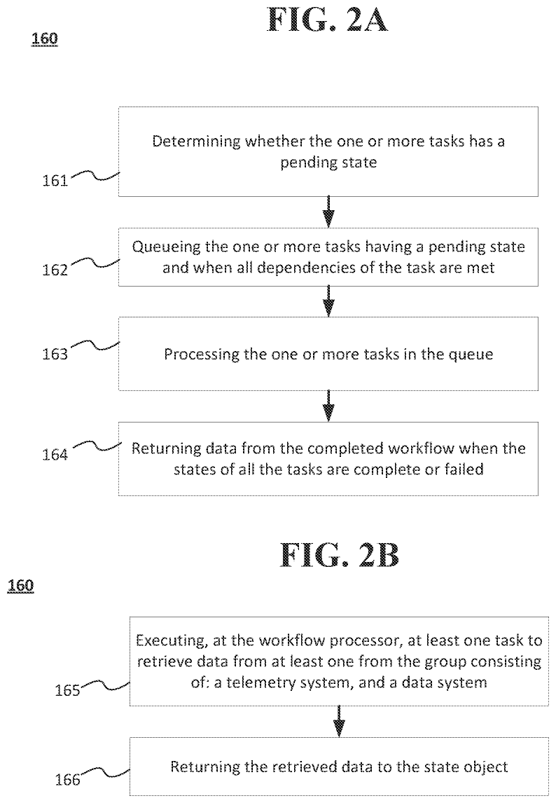

FIGS. 2A-2B show additional details of operation 160 according to implementations of the disclosed subject matter. FIG. 2A shows that the iterating through each task of the state object of operation 160 may include determining whether the one or more tasks has a pending state at operation 161. At operation 162, the when one or more tasks having a pending state and all dependencies of the task are met, the one or more tasks may be queued. At operation 163, the one or more tasks in the queue may be processed. At operation 164, data may be returned from the completed workflow when the states of all the tasks are complete or failed. If a task has failed to be processed, a notification may be transmitted (e.g., to computer 500 shown in FIG. 10).

FIG. 2B shows that the iterating through each task of the state object at operation 160 may include executing at least one task to retrieve data from at least one a telemetry system and/or a data system at operation 165. For example, the telemetry and/or data system may be Argus, Splunk, or the like. The data may be retrieved using one or more connectors (e.g., installed connectors 316 shown in FIG. 7, which may include first connector 318, second connector 320, and/or third connector 322) associated with the task being executed. The telemetry data may be used to analyze the operation of one or devices communicatively coupled to a network, such as server 902, server 904, device 906, and/or database 908 coupled to network 900 shown in FIG. 10. The telemetry data may include usage and/or performance data of the devices coupled to network 900, and may be used to determine operational issues with the devices when the devices are not operating as expected. At operation 166, the retrieved data may be returned to the state object. In some implementations, the workflow processor may coordinate the one or more tasks to be executed based on the workflow and results of the iterated tasks.

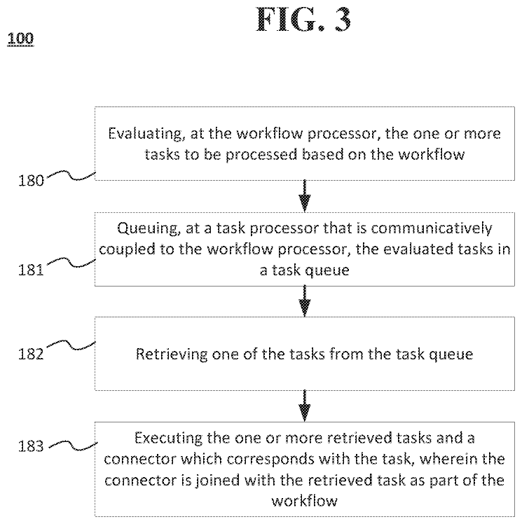

FIG. 3 shows additional details of method 100 of FIG. 1. For example, the operations shown in FIG. 3 may be performed in connection with iterating each task of the workflow as shown in operation 160 of FIG. 1 and described above. At operation 180, the one or more tasks may be evaluated to be processed based on the workflow. A task processor (e.g., task processor 326 shown in FIG. 7) may queue the evaluated tasks in a task queue at operation 181. At operation 182, one of the tasks from the task queue may be retrieved. At operation 183, the one or more retrieved tasks and a connector which corresponds with the task may be executed (e.g., first connector 318, second connector 320, and/or third connector 322 shown in FIG. 7). The connector may be joined with the retrieved task as part of the workflow.

In some implementations, a final state and results may be provided to the workflow processor (e.g., workflow processor 314 shown in FIG. 7) when the task is completed. The workflow processor may update the state object with the final state and results.

Implementations of the disclosed subject matter may provide data sharing between tasks. Data of each task of the workflow may be stored in a data storage associated with the workflow. The data of each task may be accessible by one or more other tasks of the workflow. For example, data from a first task may be accessed by a second task of the workflow when the workflow is active.

At operation 170 of FIG. 1, data may be transmitted (e.g., to computer 500 shown in FIG. 10) in response to the alert notification based on the completed workflow. For example, the data may indicate one or more operational issues with the server 902, server 904, device 906, and/or database 908 coupled to network 900 shown in FIG. 10.

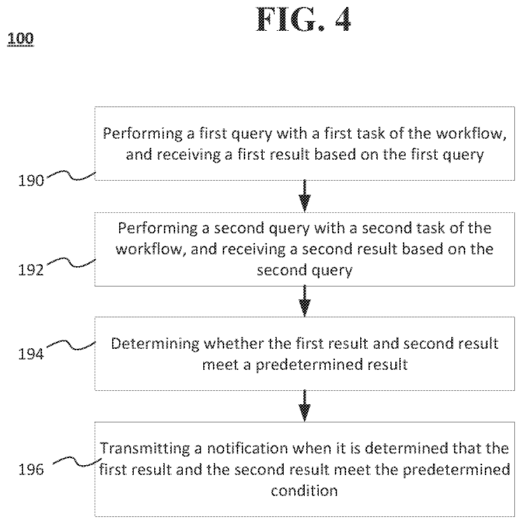

FIG. 4 shows an example method of complex conditional data evaluation for the method 100 shown in FIGS. 1-3 according to an implementation of the disclosed subject matter. At operation 190, a first query with a first task of the workflow may be performed by the workflow processor. A first result based on the first query may be received by the workflow processor. At operation 192, a second query with a second task of the workflow may be performed by the workflow processor. A second result based on the second query may be received by the workflow processor. At operation 194, the workflow processor may determine whether the first result and second result meet a predetermined result. At operation 196, a notification may be transmitted (e.g., to computer 500 shown in FIG. 10) when it is determined that the first result and the second result meet the predetermined condition. That is, the operations shown in FIG. 4 may have a plurality of conditions to be met before transmitting a notification. In some implementations, the second condition may depend on the results from the preceding task and/or condition. Although two conditions to be met are shown in FIG. 4, any suitable plurality of conditions may be used to determine whether to transmit a notification. The method shown in FIG. 4 allows for multiple data points (e.g., conditions) before a notification may be transmitted. This implementation may provide for tailoring when notifications are transmitted, so as to be useful to a system operator of the network computing system.

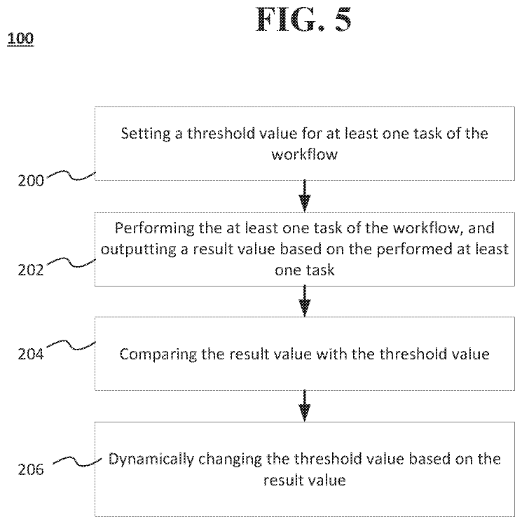

FIG. 5 shows an implementation of method 100 which includes dynamically changing a threshold value for a task of the workflow of FIGS. 1-3 according to an implementation of the disclosed subject matter. At operation 200, the workflow processor may set a threshold value for at least one task of the workflow. At operation 202, the workflow processor may perform the at least one task of the workflow, and may output a result value based on the performed at least one task. At operation 204, the workflow processor may compare the result value with the threshold value, and may dynamically change the threshold value based on the result value at operation 206. That is, the operations in FIG. 5 allow for dynamically changing threshold values, rather than having static values. Such dynamic changes may be useful as devices may be added and/or removed from network 900 shown in FIG. 10. That is, threshold values for usage, performance, number of errors, or the like of a network may change, as components of the network change, and the dynamic changes to threshold values may allow the system of the disclosed subject matter to adapt to the network changes.

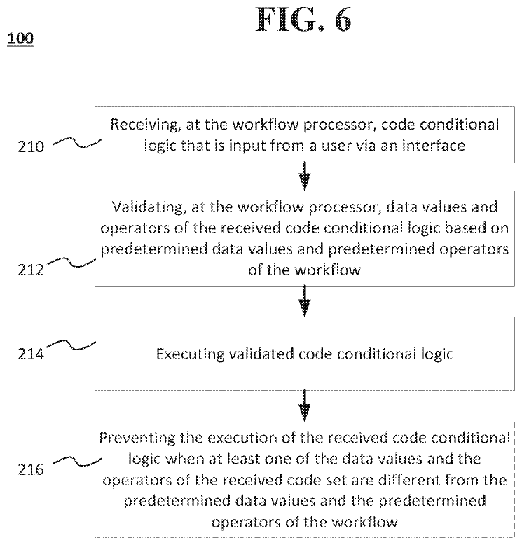

FIG. 6 shows an implementation of method 100 that includes receiving, validating, and executing code conditional logic according to an implementation of the disclosed subject matter. That is, FIG. 6 may show dynamic data evaluation decision making using code conditional logic that may be received via an interface (e.g., HTTP API 306 shown in FIG. 7). At operation 210 the workflow processor (e.g., workflow processor 314 shown in FIG. 7) may receive code conditional logic that is input from a user via an interface. For example, a user may input the code conditional logic using user input device 560 of computer 500 shown in FIG. 10, which may be received at the HTTP API 306 shown in FIG. 7 and described below. At operation 212, the workflow processor may validate data values and operators of the received code conditional logic based on predetermined data values and predetermined operators of the workflow, and may execute the validated code conditional logic at operation 214. That is, the received code conditional logic may not be executed if the data values and parameters are unable to be validated. The code conditional logic may be provided as input from the user so as to update operations while avoid altering code executed by the workflow processor for the one or more tasks. In some implementations, the method shown in FIG. 6 may include preventing the execution of the received code conditional logic when at least one of the data values and the operators of the received code set are different from the predetermined data values and the predetermined operators of the workflow.

FIG. 7 shows an example arrangement 300 of a client 302 and an instance 304 of a workflow engine according to an implementation of the disclosed subject matter. The client 302 may be computer 500 shown in FIG. 10, and the instance 304 may be provided by server 700 shown in FIG. 10. Although one instance is shown in FIG. 7, the server 700 may execute a plurality of instances, which may be responsive to one or more clients.

Client 302 may provide a notification or alert to the workflow engine instance 304. For example, the alert and/or notification may be based on one or more operational issues of server 902, server 904, device 906, database 908, and/or other devices communicatively coupled to network 900 shown in FIG. 10. The workflow engine instance 304 may include an HTTP API 306 (Hypertext Transfer Protocol Applications Program Interface). The HTTP API 306 may be an interface to receive the alert and/or notification of the network computing system (e.g., server 902, server 904, device 906, and/or database 908 of network 900). The HTTP API 306 may include a job 308, a workflow 310, and one or more connectors 312. Workflow 310 may include one or more tasks to be executed by the workflow processor 314, and job 308 may include a validated workflow. Connectors 312 may correspond with a task, and may be specific to downstream services, such as APIs (application program interfaces) or databases. The connectors may provide an interface between the task and one or more external telemetry diagnostic tool.

The workflow engine instance 304 may include workflow processor 314, which may execute one or more tasks of the workflow. The installed connectors 316 of the workflow engine instance 304 may have one or more connectors, such as first connector 318, second connector 320, third connector 322, or the like. First connector 318, second connector 320, and/or third connector 322 may each be interfaces between a task of the workflow and an external telemetry diagnostic tool. The external telemetry diagnostic tool may be used to analyze the operation of one or devices communicatively coupled to a network, such as server 902, server 904, device 906, and/or database 908 coupled to network 900 shown in FIG. 10. The external telemetry diagnostic tool may gather usage and/or performance data of the devices coupled to network 900, and may be used to determine operational issues with the devices when the devices are not operating as expected.

The workflow engine instance 304 may include job and state management 324, which may include a state engine which may act as an interface to underlying backend services (e.g., Redis, PostGres, or the like) without the need for changes to the workflow processor 314. The job and state management 324 may be used to monitor the state of the one or more tasks of a workflow being executed, and/or the state of the job being executed. For example, the state of the task and/or job may indicate whether the task and/or job is completed, and/or whether additional work is to be performed before completion. The state of the task and/or job may be stored by one or more backend services (e.g., Redis, PostGres, or the like) as appropriate for the environment. The state engine may be an interface between the workflow processor 314 and the storage device to store the state.

The workflow processor 314 may manage the processing of the job, including the communication with the state engine. The workflow processor 314 may orchestrate the tasks based on workflow content and the results of tasks as they are processed. The workflow processor 314 may evaluate which tasks are ready to be processed, and may queue such tasks in the task processor 326. The workflow processor 314 may be responsible to updating the state of the workflow as results are returned from the task processor 326. With each update, the workflow processor 314 may re-evaluate the workflow to determine if new tasks need to be queued. When the workflow processor 314 determined that the workflow is complete, the workflow processor 314 may finalize the state and the job.

Task processor 326 may execute tasks of a job of the current workflow of the workflow processor 314. The task processor 326 may act as an interface between the workflow processor 314 and one or more sub-systems that execute the tasks (e.g., Bull, RabbitMQ, or the like). Similar to the state engine, the task processor 326 may be an interface to provide the workflow processor 314 with an abstraction to one or more different queues and processors.

The task processor 326 may function as a queue for the workflow processor 314. When a task is ready for processing, the content of the task and any input parameters may be pushed into the queue of the task processor 326. When the task is picked up from the queue, a corresponding connector may execute the task. When the task has been completed, the final state and results of the task may be returned to the workflow processor 314. The workflow processor 314 may update the state object and evaluate the next steps of the job.

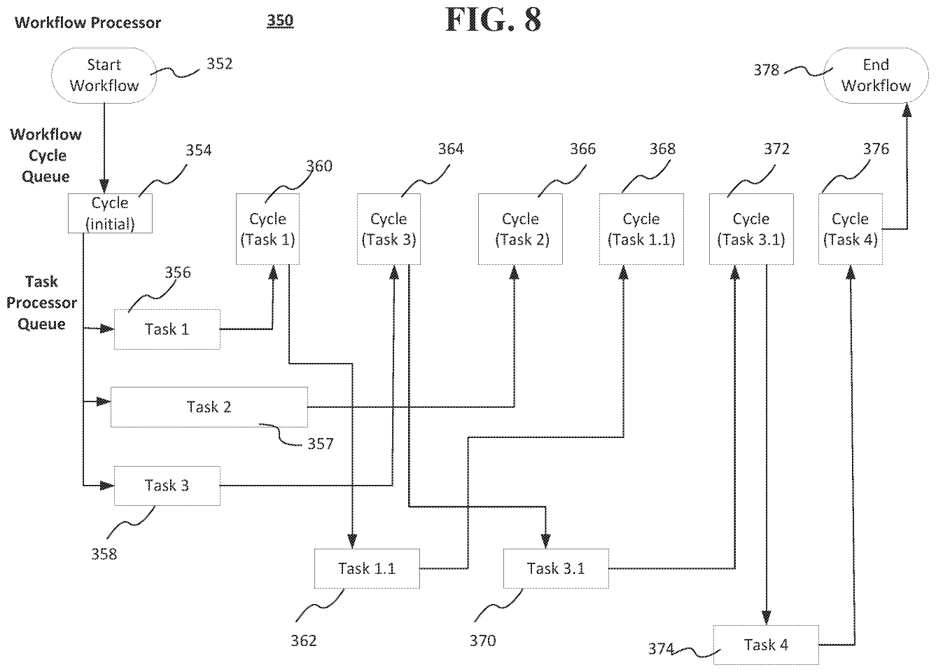

FIG. 8 shows an example of workflow processing 350 with a workflow processor (e.g., workflow processor 324 shown in FIG. 7) and a task processor (e.g., task processor 326 shown in FIG. 7) according to an implementation of the disclosed subject matter. The task processor may operate a workflow cycle queue and a task processor queue. In the example shown in FIG. 8, the workflow cycle queue may include reference numbers 354, 360, 364, 366, 368, 372, and 376. The task processor queue may include task 1, task 1.1, task 2, task 3, task 3.1, and task 4, which may be reference numbers 356, 362, 357, 358, 370, and 374, respectively.

Any task that is ready to be processed may have its content provided to the task processor queue. Task processor workers (e.g., one or more workers associated with the task processor 324 shown in FIG. 7) may process work in any order. In some implementations, the task processor workers may process work in parallel. When a task is complete, the task may make a callback (e.g., a synchronous callback) to the workflow processor to update the state of the task in the global state object. Updating the global state object may not schedule dependent tasks. Rather, the workflow cycle queue evaluates the current state of the job, and tasks may be scheduled based on the evaluation.

The workflow cycle queue shown in FIG. 8 holds each of the tasks. The workflow processor may evaluate the current job for additional work when changes have been made to the state. The workflow cycle queue may operate serially. After a task is completed, a state may be updated, and an item may be placed onto the workflow cycle queue. Workers of the workflow cycle queue may individually process the tasks to ensure the integrity of the job.

At operation 352 of FIG. 8, the workflow processor (e.g., workflow processor 314 shown in FIG. 7) may start processing a received workflow. Operation 354 may include a plurality of tasks of the workflow, which are added to a workflow cycle queue. Tasks from operation 354 may be added to the task processor queue when the content of the task in the workflow cycle queue is ready to be processed. In this example, the task processor queue may include task 1 (reference 356), task 2 (reference 357), and/or task 3 (reference 358).

Task 1 (reference 356) may be executed by the task processor queue, and may return an updated state to the workflow cycle queue based on the processing. At operation 360, the workflow cycle queue may evaluate the changed state of task 1, and may determine that additional work may be performed. The workflow cycle queue may output task 1.1 (reference 362) to the task processor queue for processing based on this evaluation. Task 1.1 may be executed by the task processor queue, and a state change may be pushed to the workflow cycle queue. The workflow cycle queue may update the state change of task 1.1, and may determine that no additional work is to be performed at operation 368, and that task 1.1 is complete. The task processor queue may process task 2 (reference 357), and provide the results to the workflow cycle queue at operation 366, which may update the state of task 2. The workflow cycle queue may determine that no additional work is to be performed, and that task 2 is complete.

The task processor queue may process task 3 (reference 358), and provide the results to the workflow cycle queue at operation 364, which may update the state of task 3. The workflow cycle queue may determine that additional work may be performed, and may provide task 3.1 (370) to the task processor queue for processing. The results of task 3.1 may be provided to the workflow cycle queue, which may update the status of task 3.1 at operation 372.

The workflow cycle queue may determine that additional work is to be performed, and may push task 4 (reference 374) to the task processor queue for processing. The result of the processing of task 4 may be provided to the workflow cycle queue, which may update that status of task 4 at operation 376. The workflow cycle queue may determine that no additional work is to be performed. In the example shown in FIG. 8, task 4 may be the last task in the workflow, and the workflow may be ended at operation 378, as the tasks of the workflow have been completed.

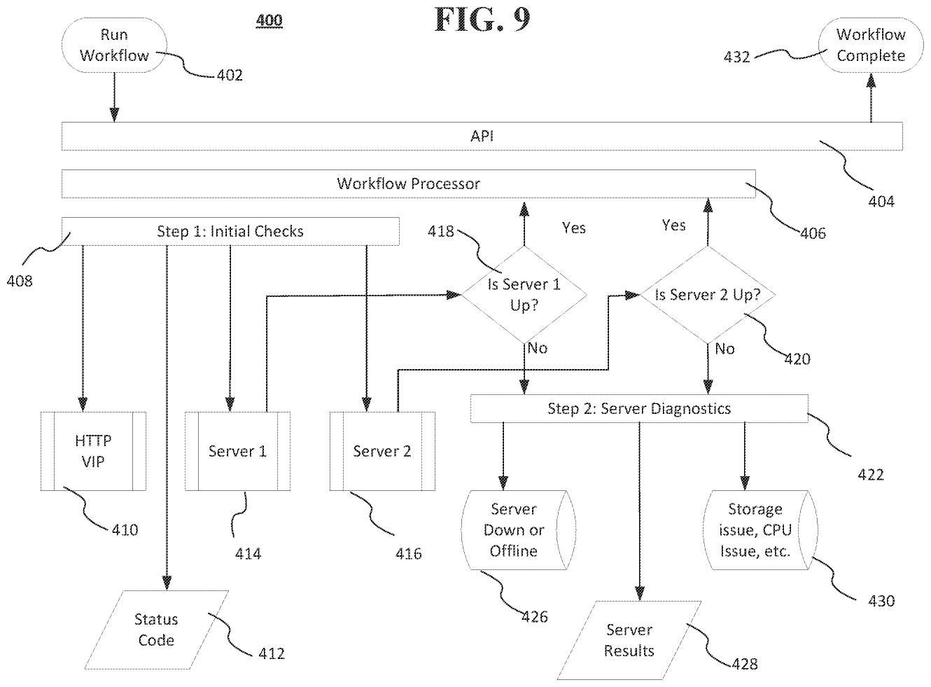

FIG. 9 shows another example of workflow processing 400 that performs initial checks and server diagnostics (e.g., of server 902, server 904, device 906, and/or database 908 of network 900 shown in FIG. 10) according to an implementation of the disclosed subject matter. In the workflow processing 400, an alert and/or notification may be received. The alert and/or notification may be received by computer 500 shown in FIG. 10 regarding the operation and/or status of server 902, server 904, device 906, and or device 908 of network 900. Tasks may be executed as part of a workflow that is selected based on the received alert to evaluate data sources. The workflow may be executed by workflow processor 406 (which may be workflow processor 314, which may be part of workflow engine instance 304 executed by server 700 shown in FIG. 10). Server diagnostic workflows may be executed for servers that are determined to be unhealthy (i.e., not operating normally). Diagnostic evaluations may be provided (e.g., to computer 500 shown in FIG. 10) after evaluation of the servers.

At operation 402, the workflow may be executed by interfacing with an application programming interface (API) 404 (e.g., which may be similar to HTTP API 306 shown in FIG. 7 as described above, which may be part of the workflow engine instance 304 that is executed by server 700 of FIG. 10). A workflow may be selected by the API 404 based on the received alert, and the selected workflow may be provided to workflow processor 406 (e.g., which may be similar to workflow processor 314 shown in FIG. 7).

At operation 408, initial checks may be performed of devices and/or servers having a virtual internet protocol address (VIP) 410, and/or one or more servers, such as server 414 (server 1) and/or server 416 (server 2). For example, device having VIP 410 may be device 906 and/or database 908 shown in FIG. 10, and the servers 414, 416 may be servers 902, 904 shown in FIG. 10. The initial checks performed in operation 408 may generate status code 412, which may indicate the operational status of devices having the VIP addresses, and/or the one or more servers (e.g., server 414 and/or server 416). The operational status as indicated by the status code 412 may include, for example, whether a device, database, server, or the like is up and operational.

For example, operation 418 may determine whether the server 414 (server 1) is up and operational. If the server 414 is up and operating, the result (i.e., that the server 414 is operational) may be provided to the workflow processor 406. If the server 414 is not up and operating, the server diagnostics may be performed at operation 422. Similarly, operation 422 may determine whether server 416 (server 2) is up and operating. If the server 416 is up and operating, the result (i.e., that the server 416 is operational) may be provided to the workflow processor 406. If the server 416 is not up and operating, the server diagnostics may be performed at operation 422. In this example, when the server 1 and/or server 2 are up and operating based on the results provided to the workflow processor 406, the results may be provided to the API 404 and the workflow may be completed at operation 432.

If server 414 and/or server 416 are not up and operating, server diagnostics may be performed at operation 422, which may determine whether the server 414 and/or server 416 is down and/or offline as shown at reference 426, and/or that there is a storage issue, a processor issue, or the like at reference 430. The results of the diagnostics performed on server 414 and/or server 416 may be reported at operation 428 (e.g., to computer 500 shown in FIG. 10).

Implementations of the presently disclosed subject matter may be implemented in and used with a variety of component and network architectures. FIG. 10 is an example computer 500 which may receive alerts and/or notifications regarding operations and/or performance issues in connection with devices connected to network 900, such as server 902, server 904, device 906 and/or database 908.

As shown in FIG. 10, the computer 500 may communicate with a server 700 (e.g., a server, cloud server, database, cluster, application server, neural network system, or the like) via a wired and/or wireless communications network 600 and/or communications network 900. Although one server 700 is shown in FIG. 10, the server 700 may be a plurality of servers, cloud servers, databases, clusters, application servers, neural network systems, or the like. The server 700 may include a storage device 710. The storage 710 may use any suitable combination of any suitable volatile and non-volatile physical storage mediums, including, for example, hard disk drives, solid state drives, optical media, flash memory, tape drives, registers, and random access memory, or the like, or any combination thereof. The server 700 may be communicatively coupled to database 800, which may use any suitable combination of any suitable volatile and non-volatile physical storage mediums, including, for example, hard disk drives, solid state drives, optical media, flash memory, tape drives, registers, and random access memory, or the like, or any combination thereof. Using the method shown in FIGS. 1-6 and described above, the server 700 may monitor and/or perform diagnostic operations in connection with server 902, server 904, device 906, and/or database 908 that are communicatively coupled to the devices

The storage 710 of the server 700 and/or database 800 can store data, such as content and/or components to be placed in a page, groups of one or more users, executable script, subdata, subcomponents, output types, or the like. Further, if the storage 710 and/or database 800 is a multitenant system, the storage 710 and/or database 800 can be organized into separate log structured merge trees for each instance of a database for a tenant. Alternatively, contents of all records on a particular server or system can be stored within a single log structured merge tree, in which case unique tenant identifiers associated with versions of records can be used to distinguish between data for each tenant as disclosed herein. More recent transactions can be stored at the highest or top level of the tree and older transactions can be stored at lower levels of the tree. Alternatively, the most recent transaction or version for each record (i.e., contents of each record) can be stored at the highest level of the tree and prior versions or prior transactions at lower levels of the tree.

The computer (e.g., user computer, enterprise computer, or the like) 500 may include a bus 510 which interconnects major components of the computer 500, such as a central processor 540, a memory 570 (typically RAM, but which can also include ROM, flash RAM, or the like), an input/output controller 580, a user display 520, such as a display or touch screen via a display adapter, a user input interface 560, which may include one or more controllers and associated user input or devices such as a keyboard, mouse, Wi-Fi/cellular radios, touchscreen, microphone/speakers and the like, and may be communicatively coupled to the I/O controller 580, fixed storage 530, such as a hard drive, flash storage, Fibre Channel network, SAN device, SCSI device, and the like, and a removable media component 550 operative to control and receive an optical disk, flash drive, and the like.

The bus 510 may enable data communication between the central processor 540 and the memory 570, which may include read-only memory (ROM) or flash memory (neither shown), and random access memory (RAM) (not shown), as previously noted. The RAM may include the main memory into which the operating system, development software, testing programs, and application programs are loaded. The ROM or flash memory can contain, among other code, the Basic Input-Output system (BIOS) which controls basic hardware operation such as the interaction with peripheral components. Applications resident with the computer 500 may be stored on and accessed via a computer readable medium, such as a hard disk drive (e.g., fixed storage 530), an optical drive, floppy disk, or other storage medium 550.

The fixed storage 530 can be integral with the computer 500 or can be separate and accessed through other interfaces. The fixed storage 530 may be part of a storage area network (SAN). A network interface 590 can provide a direct connection to a remote server via a telephone link, to the Internet via an internet service provider (ISP), or a direct connection to a remote server via a direct network link to the Internet via a POP (point of presence) or other technique. The network interface 590 can provide such connection using wireless techniques, including digital cellular telephone connection, Cellular Digital Packet Data (CDPD) connection, digital satellite data connection or the like. For example, the network interface 590 may enable the computer to communicate with other computers and/or storage devices via one or more local, wide-area, or other networks, such as communications network 600.

Computer 500 and/or server 700 may be communicatively coupled to communications network 900. Server 902, server 904, device 906, and/or database 908 may be communicatively coupled to the network 900. Server 902, 904 may be a server, cloud server, database, cluster, application server, neural network system, or the like. Device 906 may be a computer, tablet, wearable computing device, smart phone, or the like. Database 908 may use any suitable combination of any suitable volatile and non-volatile physical storage mediums, including, for example, hard disk drives, solid state drives, optical media, flash memory, tape drives, registers, and random access memory, or the like, or any combination thereof. Network 900 may include additional devices, databases, servers, or the like.

Many other devices or components (not shown) may be connected in a similar manner (e.g., data cache systems, application servers, communication network switches, firewall devices, authentication and/or authorization servers, computer and/or network security systems, and the like). Conversely, all the components shown in FIG. 10 need not be present to practice the present disclosure. The components can be interconnected in different ways from that shown. Code to implement the present disclosure can be stored in computer-readable storage media such as one or more of the memory 570, fixed storage 530, removable media 550, or on a remote storage location.

The systems and methods of the disclosed subject matter can be for single tenancy and/or multitenancy systems. Multitenancy systems can allow various tenants, which can be, for example, developers, users, groups of users, and/or organizations, to access their own records (e.g., tenant data and the like) on the server system through software tools or instances on the server system that can be shared among the various tenants. The contents of records for each tenant can be part of a database containing that tenant. Contents of records for multiple tenants can all be stored together within the same database, but each tenant can only be able to access contents of records which belong to, or were created by, that tenant. This may allow a database system to enable multitenancy without having to store each tenants' contents of records separately, for example, on separate servers or server systems. The database for a tenant can be, for example, a relational database, hierarchical database, or any other suitable database type. All records stored on the server system can be stored in any suitable structure, including, for example, a log structured merge (LSM) tree.

Further, a multitenant system can have various tenant instances on server systems distributed throughout a network with a computing system at each node. The live or production database instance of each tenant may have its transactions processed at one computer system. The computing system for processing the transactions of that instance may also process transactions of other instances for other tenants.

Some portions of the detailed description are presented in terms of diagrams or algorithms and symbolic representations of operations on data bits within a computer memory. These diagrams and algorithmic descriptions and representations are commonly used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

It should be borne in mind, however, that all these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “determining,” “retrieving,” “generating,” “serializing,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

More generally, various implementations of the presently disclosed subject matter can include or be implemented in the form of computer-implemented processes and apparatuses for practicing those processes. Implementations also can be implemented in the form of a computer program product having computer program code containing instructions implemented in non-transitory and/or tangible media, such as hard drives, solid state drives, USB (universal serial bus) drives, CD-ROMs, or any other machine readable storage medium, wherein, when the computer program code is loaded into and executed by a computer, the computer becomes an apparatus for practicing implementations of the disclosed subject matter. Implementations also can be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium can be implemented by a general-purpose processor, which can transform the general-purpose processor or a device containing the general-purpose processor into a special-purpose device configured to implement or carry out the instructions. Implementations can be implemented using hardware that can include a processor, such as a general purpose microprocessor and/or an Application Specific Integrated Circuit (ASIC) that implements all or part of the techniques according to implementations of the disclosed subject matter in hardware and/or firmware. The processor can be coupled to memory, such as RAM, ROM, flash memory, a hard disk or any other device capable of storing electronic information. The memory can store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described to explain the principles of implementations of the disclosed subject matter and their practical applications, to thereby enable others skilled in the art to utilize those implementations as well as various implementations with various modifications as can be suited to the particular use contemplated.

1. A method comprising:
executing, at workflow processor, a workflow based on a received alert notification, wherein the workflow includes one or more tasks to be executed by the workflow processor;
determining, at the workflow processor, whether each task of the workflow is executable without failure;
validating, at the workflow processor, the workflow when it is determined that each task of the workflow is executable without failure;
generating, at the workflow processor, a job based on the validated workflow;
generating, at the workflow processor, a state object in a state engine to be used by the job for processing by the workflow processor;
iterating, at the workflow processor, each task of the state object to complete the workflow; and
transmitting, at the workflow processor, data in response to the alert notification based on the completed workflow.

2. The method of claim 1, wherein the iterating through each task of the state object comprises:
determining whether the one or more tasks has a pending state;
queueing the one or more tasks having a pending state and when all dependencies of the task are met;
processing the one or more tasks in the queue; and
returning data from the completed workflow when the states of all the tasks are complete or failed.

3. The method of claim 1, wherein the iterating through each task of the state object comprises:
executing, at the workflow processor, at least one task to retrieve data from at least one from the group consisting of: a telemetry system, and a data system; and
returning the retrieved data to the state object.

4. The method of claim 1, wherein the validating the workflow comprises:
validating at least one selected from the group consisting of: one or more input parameters that have a first predetermined structure for the at least one task, one or more workflow parameters have a second predetermined structure for the at least one task, and the one or more workflow parameters match data points of the workflow.

5. The method of claim 1, further comprising:
coordinating, at the workflow processor, the one or more tasks to be executed based on the workflow and results of the iterated tasks.

6. The method of claim 1, further comprising:
evaluating, at the workflow processor, the one or more tasks to be processed based on the workflow; and
queuing, at a task processor that is communicatively coupled to the workflow processor, the evaluated tasks in a task queue.

7. The method of claim 5, further comprising:
retrieving one of the tasks from the task queue; and
executing the one or more retrieved tasks and a connector which corresponds with the task, wherein the connector is joined with the retrieved task as part of the workflow.

8. The method of claim 1, wherein the generating the state object comprises:
managing, at the generated state object, a state of the job; and
storing the results of the iterated one or more tasks.

9. The method of claim 1, further comprising:
storing, using a state engine communicatively coupled to the workflow processor, a state of a task in a storage device.

10. The method of claim 1, further comprising:
providing, to the workflow processor, a final state and results when the task is completed; and
updating, at the workflow processor, the state object.

11. The method of claim 1, further comprising:
storing data of each task of the workflow in a data storage associated with the workflow, wherein the data of each task is accessible by one or more other tasks of the workflow.

12. The method of claim 11, further comprising:
accessing data from a first task with a second task of the workflow when the workflow is active.

13. The method of claim 1, further comprising:
performing a first query with a first task of the workflow, and receiving a first result based on the first query;
performing a second query with a second task of the workflow, and receiving a second result based on the second query;
determining whether the first result and second result meet a predetermined result; and
transmitting a notification when it is determined that the first result and the second result meet the predetermined condition.

14. The method of claim 1, further comprising:
setting a threshold value for at least one task of the workflow;
performing the at least one task of the workflow, and outputting a result value based on the performed at least one task;
comparing the result value with the threshold value; and
dynamically changing the threshold value based on the result value.

15. The method of claim 1, further comprising:
receiving, at the workflow processor, code conditional logic that is input from a user via an interface;
validating, at the workflow processor, data values and operators of the received code conditional logic based on predetermined data values and predetermined operators of the workflow; and
executing validated code conditional logic.

16. The method of claim 15, further comprising:
preventing the execution of the received code conditional logic when at least one of the data values and the operators of the received code set are different from the predetermined data values and the predetermined operators of the workflow.

17. The method of claim 15, wherein the code conditional logic is provided as input from the user so as to avoid altering code executed by the workflow processor for the one or more tasks.

18. A system comprising:
a server comprising a workflow processor coupled to a memory to:
execute a workflow based on a received alert notification, wherein the workflow includes one or more tasks to be executed by the workflow processor;
determine whether each task of the workflow is executable without failure;
validate the workflow when it is determined that each task of the workflow is executable without failure;
generate a job based on the validated workflow;
generate a state object in a state engine to be used by the job for processing by the workflow processor;
iterate each task of the state object to complete the workflow; and
transmit data in response to the alert notification based on the completed workflow.

19. The system of claim 18, wherein the workflow processor iterates through each task of the state object by determining whether the one or more tasks has a pending state, queueing the one or more tasks having a pending state and when all dependencies of the task are met, processing the one or more tasks in the queue, and returning data from the completed workflow when the states of all the tasks are complete or failed.

20. The system of claim 18, wherein the workflow processor iterates through each task of the state object by executing at least one task to retrieve data from at least one from the group consisting of: a telemetry system, and a data system, and returning the retrieved data to the state object.

21. The system of claim 18, wherein the workflow processor validates the workflow by validating at least one selected from the group consisting of: one or more input parameters that have a first predetermined structure for the at least one task, one or more workflow parameters have a second predetermined structure for the at least one task, and the one or more workflow parameters match data points of the workflow.

22. The system of claim 18, wherein the workflow processor coordinates the one or more tasks to be executed based on the workflow and results of the iterated tasks.

23. The system of claim 18, wherein the workflow processor evaluates the one or more tasks to be processed based on the workflow; and
a task processor, communicatively coupled to the workflow processor, to queue the evaluated tasks in a task queue.

24. The system of claim 23, wherein the task processor retrieves one of the tasks from the task queue, and executes the one or more retrieved tasks and a connector which corresponds with the task, wherein the connector is joined with the retrieved task as part of the workflow.

25. The system of claim 18, wherein the task processor generates the state object by managing, at the generated state object, a state of the job, and storing the results of the iterated one or more tasks.

26. The system of claim 18, further comprising:
a state engine, communicatively coupled to the workflow processor, to store a state of a task in a storage device.

27. The system of claim 18, wherein the workflow processor provides a final state and results when the task is completed, and updates the state object.

28. The system of claim 18, wherein the workflow processor stores data of each task of the workflow in a data storage associated with the workflow, wherein the data of each task is accessible by one or more other tasks of the workflow.

29. The system of claim 28, wherein the workflow processor accesses data from a first task with a second task of the workflow when the workflow is active.

30. The system of claim 18, wherein the workflow processor performs a first query with a first task of the workflow, receives a first result based on the first query, performs a second query with a second task of the workflow, and receives a second result based on the second query, and
wherein the workflow processor determines whether the first result and second result meet a predetermined result, and transmits a notification when it is determined that the first result and the second result meet the predetermined condition.

31. The system of claim 18, wherein the workflow processor set a threshold value for at least one task of the workflow, performs the at least one task of the workflow and outputting a result value based on the performed at least one task, compares the result value with the threshold value, and dynamically changes the threshold value based on the result value.

32. The system of claim 18, wherein the workflow processor receives code conditional logic that is input from a user via an interface, validates data values and operators of the received code conditional logic based on predetermined data values and predetermined operators of the workflow, and executes validated code conditional logic.

33. The system of claim 32, wherein the workflow processor prevents the execution of the received code conditional logic when at least one of the data values and the operators of the received code set are different from the predetermined data values and the predetermined operators of the workflow.

34. The system of claim 32, wherein the code conditional logic is provided as input from the user so as to avoid altering code executed by the workflow processor for the one or more tasks.
